(19) United States
(12) Patent Application Publication
(10) Pub. No.: US 2021/0048406 A1
(43) Pub. Date: Feb. 18, 2021

(54) ELECTROCHEMICAL SENSOR AND METHOD OF FORMING THEREOF

(71) Applicant: Analog Devices International Unlimited Company, Limerick (IE)

(72) Inventors: Alfonso Berduque, Crusheen (IE); Youri Victorovitch Ponomarev, Rotselaar (BE); Brendan Cawley, Patrickswell (IE); Donal McAuliffe, Raheen (IE); Raymond J. Speer, Dalkey (IE)

(21) Appl. No.: 16/539,531

(22) Filed: Aug. 13, 2019

(51) Int. Cl. G01N 27/404

(52) U.S. Cl. CPC G01N 27/404

(57) ABSTRACT

Electrochemical sensors typically include capillaries or openings in a substrate which allow the gas present in the environment to make its way into the sensor. The present disclosure proposes the use of a hydrophobic layer, coating or surface in various arrangements around these openings in order to help prevent or restrict electrolyte leaving the sensor and also prevent moisture or other liquids entering the sensor. In some such electrochemical sensors, the hydrophobic layer acts to prevent or restrict electrolyte from drying out or leaving the sensor. In other such electrochemical sensors, there is a porous electrode and a liquid electrolyte, with the hydrophobic layer repelling the electrolyte from passing through the electrode and out of the electrochemical sensor. In yet other such electrochemical sensors, the sensor is manufactured forming at least one layer of hydrophobic material in order to help prevent or restrict electrolyte from drying out or from leaving the sensor, and also prevent or restrict moisture or other liquids entering the sensor.

### FIELD OF THE DISCLOSURE

The present disclosure relates to an electrochemical sensor having a hydrophobic layer. The present disclosure also relates to a method of forming such an electrochemical sensor having a hydrophobic layer.

### BACKGROUND

Electrochemical gas sensors can include a substrate upon which one or more electrodes and an electrolyte reside. An example of such a sensor is disclosed in the applicant's co-pending application U.S. Ser. No. 15/251,833, which is incorporated herein by reference. The electrodes or the electrolyte are exposed to the natural environment by one or more holes or pores provided in a portion of the housing. For example, a plurality of capillaries may be provided in a substrate upon which the electrodes and electrolyte are formed. When certain gases enter the device via the openings, an electrochemical reaction occurs which may be sensed by connections to the electrodes.

### SUMMARY OF THE DISCLOSURE

Electrochemical sensors include capillaries or openings in a substrate which allow the gas present in the environment to make its way into the sensor. The present disclosure proposes the use of a hydrophobic layer, coating or surface in various arrangements around these openings such as to prevent or restrict electrolyte leaving the sensor and also prevent or restrict moisture or other liquids entering the sensor.

In some such electrochemical sensors, the hydrophobic layer can act to help prevent or restrict electrolyte from drying out or leaving the sensor. In other such electrochemical sensors, there is a porous electrode and a liquid electrolyte, with the hydrophobic layer helping repel the electrolyte from passing through the electrode and out of the electrochemical sensor. In yet other such electrochemical sensors, the sensor can be manufactured forming at least one layer of hydrophobic material such as to help prevent or restrict electrolyte from drying out or from leaving the sensor, and also to help prevent or restrict moisture or other liquids entering the sensor.

In accordance with a first aspect of the disclosure, there is provided an electrochemical sensor, comprising a substrate having one or more gas transmission openings formed therein, the openings arranged to allow gases to pass through the substrate; two or more electrodes; an electrolyte; and a hydrophobic layer arranged to prevent or restrict the electrolyte from drying out or from leaving the electrochemical sensor.

The hydrophobic layer advantageously has the effect of preventing or slowing down the electrolyte from drying out or escaping via the one or more gas transmission openings in the device. In other words, the hydrophobic layer can eliminate or minimise the risks of electrolyte leakage. Therefore, the electrolyte remains within the device and so the device can continue to operate efficiently throughout its lifetime.

Another effect that the hydrophobic layer provides is that it prevents or slows down water, water-based substances or contaminants making their way within the device via the one or more gas transmission openings, which can impede the passage of gases from the environment into the device and thus cause deterioration of its effectiveness.

At least one of the electrodes may be arranged over the hydrophobic layer. The hydrophobic layer may be arranged in contact with said at least one electrode. For example, the hydrophobic layer may be placed on top of the one or more gas transmission openings but below an electrode. In another example, the hydrophobic layer may be placed below the one or more gas transmission openings and below an electrode that extends down into the one or more gas transmission openings. By “contact”, this could be direct or indirect contact. Direct contact provides a particularly good effect of improving sealing of the one or more gas transmission openings using the hydrophobic layer as a waterproof barrier.

According to some examples, the hydrophobic layer may be arranged above the substrate and over the one or more gas transmission openings. By “above” and “over”, it will be appreciated that this refers to the orientation of the electrochemical sensor as it is manufactured rather than any orientation of the electrochemical sensor in use.

When the electrochemical sensor further comprises an insulating layer formed on top of the substrate, the hydrophobic layer may be arranged in an opening in the insulator layer. In practice, there is usually an insulating layer when the substrate is made of silicon because it acts to isolate conductors, (for example, conductive tracks that connect the electrode to external circuitry) of the device from the substrate. In order to allow the gases to reach the electrodes, an opening is formed in the insulating layer, and the opening is preferably aligned with the microcapillaries.

The electrodes may be screen or stencil printed onto the insulating layer, such that one of the electrodes is also formed in the opening in the insulating layer, and against the top surface of the hydrophobic layer. As an alternative, the electrodes may be deposited using lithographic deposition techniques. In order for the gases and the electrolyte to interact, the electrode may be porous. A benefit of such an arrangement is that it is easily manufactured using micromachining techniques. As such, the sensors may be reduced in size, and produced in such a manner that multiple sensors have the same characteristics. Further, process variations are not as great as for sensors that are made individually.

In one example, the hydrophobic layer may comprise a gas permeable hydrophobic membrane. The gas permeable hydrophobic membrane may comprise a discrete polytetrafluoroethylene, PTFE, disc, or a PTFE ink or paste. An advantage of using the discrete PTFE disc is that it delivers good and reliable results. When the gas permeable hydrophobic membrane comprises a PTFE ink or paste, this is screen printed onto the substrate through the opening in the insulating layer and then baked for uniformity and to allow the PTFE ink or paste to become gas permeable.

In another example, the hydrophobic layer may comprise SU8, which is a gas permeable epoxy-based negative photoresist. The SU8 may be arranged directly over the one or more gas transmission openings in a gap in the insulating layer (with or without micro or nanocapillaries), or the SU8 may be arranged directly over the insulating layer and the insulating layer comprises micro or nanocapillaries that are preferably aligned with micro or nanocapillaries in the SU8. By “nanocapillary”, it is meant that this opening is smaller in diameter than the microcapillaries provided in the substrate.

According to some examples, the hydrophobic layer may be arranged below the substrate of the electrochemical sensor and below the one or more gas transmission openings. By “below”, it will be appreciated that this refers to the orientation of the electrochemical sensor as it is manufactured rather than any orientation of the electrochemical sensor in use. In this case, the hydrophobic layer may comprise a hydrophobic tape and the at least one electrode against which the hydrophobic layer is arranged extends directly into the one or more gas transmission openings. The at least one electrode may comprise a gas permeable material. The gas permeable material may preferably be platinum black. One or more other high surface area catalysts (e.g. Ruthenium black, Gold Black, Iridium black) may also be used to detect different gases, and even non-high surface area catalysts can be used for other applications, including liquid sensing.

The electrochemical sensor may include a cap formed over the electrodes. The cap may be formed from glass, ceramic, silicon or plastic. The cap may be sealed to a passivation layer of the electrochemical sensor or bonded in another way. A hole may be formed in the top of the cap to allow the sensor to be filled with the electrolyte and the electrochemical sensor may further include the electrolyte provided within the cap.

In accordance with a second aspect of the disclosure, there is provided a gas sensor package, comprising: a substrate having one or more gas transmission openings formed therein, the openings arranged to allow gases to enter the substrate; a porous electrode; a liquid electrolyte formed on top of the electrode; a hydrophobic layer arranged to directly contact the electrode and arranged to repel electrolyte that would otherwise pass through the electrode and out of the electrochemical sensor. The gas sensor package may also comprise a housing for holding the liquid electrolyte.

Without the hydrophobic layer, the porous electrode would allow electrolyte to pass through to the one or more gas transmission openings and so the device would be more susceptible to drying out or leaking. Thus, the hydrophobic layer acts as a barrier against electrolyte escaping the electrochemical sensor via the one or more gas transmission openings and the sensor can continue to operate efficiently throughout its lifetime.

In accordance with a third aspect of the disclosure, there is provided a method of manufacturing an electrochemical sensor, the method comprising: providing a substrate having one or more gas transmission openings, the openings arranged to allow gases to pass through the substrate; forming a hydrophobic layer; forming two or more electrodes; and forming an electrolyte over the two or more electrodes, wherein forming the hydrophobic layer comprises arranging the hydrophobic layer to prevent or restrict the electrolyte from drying out or from leaving the electrochemical sensor.

The hydrophobic layer advantageously has the effect of preventing or restricting the electrolyte from drying out or escaping via the one or more gas transmission openings in the device. Therefore, the electrolyte remains within the device and so the device can continue to operate efficiently throughout its lifetime.

Another effect that the hydrophobic layer provides is that it prevents or restricts water, water-based substances or contaminants making their way within the device via the one or more gas transmission openings, which can impede the passage of gases from the environment into the device and thus cause deterioration of its effectiveness.

The step of forming at least one of the electrodes may comprise forming said at least one electrode over the hydrophobic layer and preferably forming said at least one electrode in contact with the hydrophobic layer. For example, the hydrophobic layer may be placed over the one or more gas transmission openings but below an electrode. In another example, the hydrophobic layer may be placed below the one or more gas transmission openings and below an electrode that extends down into the one or more gas transmission openings. Forming the electrode in direct contact with the hydrophobic layer has a particularly good effect of improving sealing of the one or more gas transmission openings using the hydrophobic layer as a waterproof barrier.

The method may further comprise forming an insulating layer on the substrate. In practice, there is usually an insulating layer when the substrate is made of silicon because it acts to isolate conductors, (for example, conductive tracks that connect the electrode to external circuitry) of the device from the substrate. In order to allow the gases to reach the electrodes, an opening may be formed in the insulating layer, the opening being aligned with the microcapillaries. Then, the hydrophobic layer may be arranged in the opening in the insulator layer.

In one example, the method may further comprise providing an opening in the insulating layer and placing a discrete PTFE disc over the one or more gas transmission openings in the opening in the insulating layer.

In another example, the method may further comprise providing an opening in the insulating layer, screen printing a PTFE ink or paste over the substrate in the opening in the insulating layer and baking the PTFE ink or paste such that it becomes gas permeable.

In another example, the method further comprises providing an opening in the insulating layer and applying SU8 in the opening in the insulating layer.

In another example, the method may further comprise applying SU8 above the insulator layer and etching, in a single etching step, nanocapillaries in the SU8 and the insulating layer such that the nanocapillaries are aligned. By “nanocapillary”, it is meant that this opening is smaller in diameter than the microcapillaries provided in the substrate.

In another example, the method may further comprise applying a hydrophobic tape to the bottom of the substrate and forming at least one electrode by filling the one or more gas transmission openings with a gas permeable material.

In each of the above examples, advantages associated with one aspect of the disclosure may also be associated with another aspect of the disclosure if appropriate.

### BRIEF DESCRIPTION OF THE DRAWINGS

Examples of the present disclosure will now be described, by non-limiting example only, with reference to the accompanying drawings, in which:

FIG. 1A is a cross-sectional view of an electrochemical sensor in accordance with a first example of the disclosure;

FIG. 1B is a plan view of an electrochemical sensor in accordance with the another example of the disclosure;

FIG. 1C schematically illustrates a substrate at an initial phase of a fabrication process for the electrochemical sensor shown in FIGS. 1A and 1B;

FIG. 1D shows the substrate after formation of an insulating layer;

FIG. 1E shows the substrate after formation of microcapillaries;

FIG. 1F shows the substrate after formation of a metal layer;

FIG. 1G shows the substrate after deposition and definition of the passivation layer;

FIG. 1H shows the substrate after removal of a portion of the insulating layer;

FIG. 1I shows the substrate after placement of the hydrophobic layer;

FIG. 1J shows the substrate after deposition of electrodes;

FIG. 1K shows the substrate after application of a cap;

FIG. 1L shows the substrate after insertion of an electrolyte and sealing of the cap;

FIG. 2 is a cross-sectional view of an electrochemical sensor in accordance with a second example of the disclosure;

FIG. 3 is a cross-sectional view of an electrochemical sensor in accordance with a third example of the disclosure;

FIG. 4 is a cross-sectional view of an electrochemical sensor in accordance with a fourth example of the disclosure;

FIG. 5 is a cross-sectional view of an electrochemical sensor in accordance with a fifth example of the disclosure;

FIG. 6 is a flow diagram showing the steps in a method in accordance with another example of the disclosure;

FIG. 7 is a flow diagram showing options for additional steps in methods in accordance with further examples of the disclosure;

FIG. 8 is a flow diagram showing options for additional steps in methods in accordance with further examples of the disclosure;

FIG. 9 is a flow diagram showing options for additional steps in methods in accordance with further examples of the disclosure;

FIG. 10 is a flow diagram showing options for additional steps in methods in accordance with further examples of the disclosure;

FIG. 11 is a flow diagram showing options for additional steps in methods in accordance with further examples of the disclosure.

### DETAILED DESCRIPTION

During manufacture, an electrochemical sensor may be filled with a suitable electrolyte. The electrolyte sits over the electrodes in the sensor's active region. Over time, the electrolyte may dry out or escape via the openings in the device. As the electrolyte shrinks, it may recede from the active region of the sensor, causing the sensor to operate ineffectively, or not at all. The openings in the device can allow the liquid electrolyte to leak out of the sensor, particularly in extreme environmental conditions. This could lead to a negative impact on the device performance or even to failure of the device. Furthermore, the openings in the device may allow water or contaminants to make their way within the device. This can also affect the operation of the device. Furthermore, if water condensation forms in the openings in the device, it may be impossible for gases from their natural environment to make their way into the device. Again, this means the device may operate ineffectively.

In the present disclosure, improvements to prevent or restrict the electrolyte from drying out or escaping the sensor are made by using a hydrophobic layer in a micromachined electrochemical sensor or an electrochemical sensor within an integrated circuit.

A hydrophobic material is one that repels water. The hydrophobic layer may be provided as a coating by itself or it may be provided as a hydrophobic surface of another material. In electrochemical sensors which are manufactured using micromachining techniques and which are reduced in size compared with discrete sensors, the hydrophobic layer may also be applied using thin film deposition techniques. Alternatively, the hydrophobic layer may be a discrete component that is deposited using a mechanical technique that needs to be incorporated into the other micromachining steps for manufacturing the electrochemical sensor. Either way, the hydrophobic layer should ensure that the electrolyte does not dry out too quickly over the lifetime of the sensor by slowing down the drying out process, the sensors/devices are much more stable over their working life.

The electrochemical sensor may have two or more electrodes. Typically, at least two electrodes are provided, a working electrode and a counter electrode, and the potential difference, current flow or resistance between these electrodes may be measured in order to determine whether a gas has entered through openings in the substrate of the device. Sometimes, a third electrode, a reference electrode, is also provided, which is held at a constant potential with respect to the working electrode. The presence of substances which interact with the working electrode/electrolyte interface can invoke current flow between the working electrode and the counter electrode as a result of reduction/oxidation reactions at the working electrode.

Within the sensor, at least the working electrode can be formed such that it is in contact with the hydrophobic layer so as to achieve better retention of electrolyte. By “contact”, it is meant that the hydrophobic layer may be formed in direct contact with the working electrode, or the contact may be indirect in that another layer of material is formed therebetween. A hydrophobic material may be placed between the working electrode and the opening in the substrate, or between the working electrode and the environment. As such, the electrolyte, provided within the sensor, is prevented, or discouraged, from leaking through the openings, by virtue of the hydrophobic material or surfaces. Furthermore, the electrolyte is less likely to dry out, as water is less able, or unable, to escape via the opening. In addition, water is prevented or restricted from entering the device via the openings, reducing the risk of contaminants entering the device. Finally, condensation is prevented or restricted from forming in the openings, ensuring that the openings are not blocked by condensation.

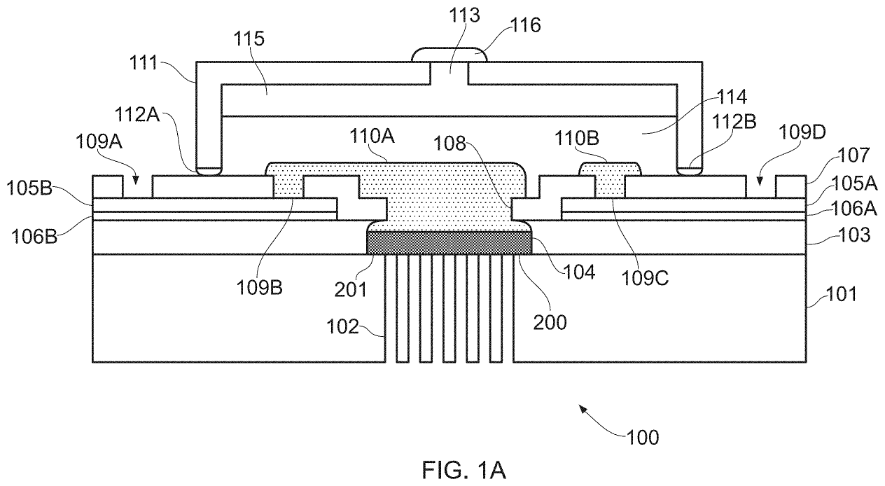

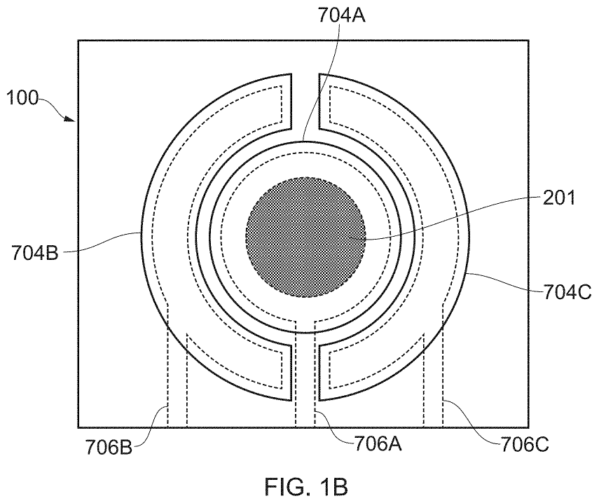

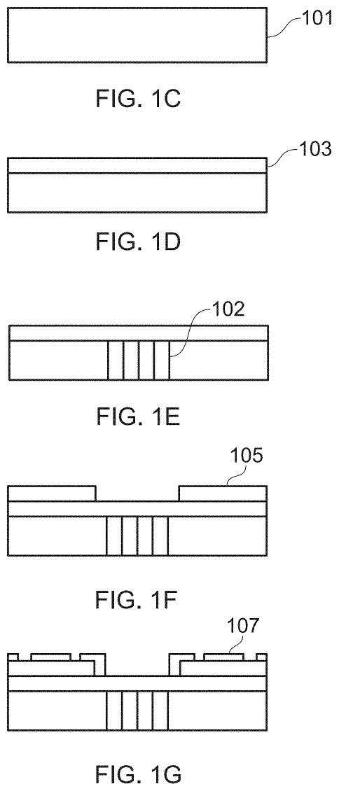

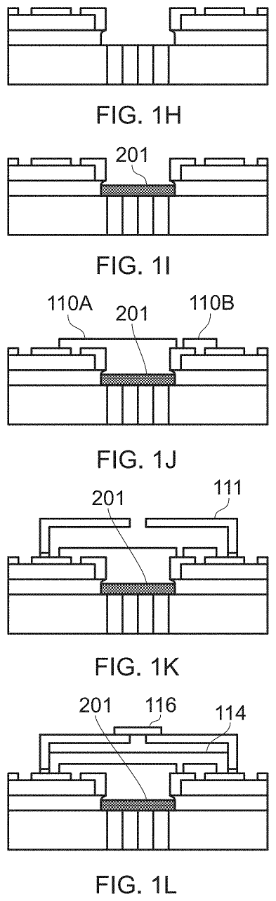

FIG. 1 shows a cross-section through an electrochemical sensor 100 formed on silicon using micromachining techniques in accordance with a first example of the disclosure. An example of such a sensor is disclosed in the applicant's co-pending application U.S. Ser. No. 15/251,833 which is incorporated herein by reference. The electrochemical sensor is formed on a silicon substrate 101. In this example, a single sensor is formed on the silicon substrate 101. However, in practice, several sensors may be formed on a single substrate, in a similar manner to the way in which multiple integrated circuits may be formed on a single silicon substrate. As an alternative to silicon, the substrate may be made from glass, ceramic or plastic. A plurality of microcapillaries 102 are formed in the substrate 101. In FIG. 1, six microcapillaries are shown in cross-section. However, the microcapillaries 102 are also formed across the width of the substrate, and there may be typically ten or more microcapillaries, or a single microcapillary. Each microcapillary is formed in a direction orthogonal to the surface of the substrate 101, and extends from an upper surface to a lower surface of the substrate. Each microcapillary is approximately 20 μm in diameter, although each microcapillary may be in the range of 1 μm to 2 mm in diameter. The group of microcapillaries 102 is approximately 1 mm across, but may be in the range of 0.001 mm to 3 mm across.

An insulating layer 103 is formed on the upper surface of the substrate 101. The insulating layer 103 may be formed from silicon oxide (SiO2) and is approximately 4 μm thick. An electrode opening 104 is formed in the insulating layer 103 in a position that is aligned with the microcapillaries 102. The opening is described as being aligned in the sense that the microcapillaries are formed in an area defined by the opening in the insulating layer. The walls of the opening 104 are not necessarily precisely aligned with the walls of the microcapillaries. In this example, the opening 104 is approximately circular, but may be square or rectangular. The opening 104 may be 1 to 2 mm across. The side walls of the opening 104 are straight in shape. However, it will be appreciated that the side walls may be semi-circular or may be formed from any other shape that increases the surface area of the side walls.

Conductive tracks 105A, 105B are formed on a top surface of the insulating layer 103. The conductive tracks 105A, 105B are adhered to the insulating layer 103 by an adhesion layer 106A, 106B. The conductive tracks 105A, 105B may be made of gold or any other suitable conductive material. For example, the conductive tracks may be made from metal or conductive plastic. The conductive tracks are arranged such that they stop approximately 25 μm from the edge of the opening 104. The tracks may stop anywhere between a few microns to a few millimeters from the edge of the opening. The conductive tracks 105A, 105B are for connecting the electrodes to external circuit elements. The conductive tracks may extend into the opening formed in the insulating layer 103. Additionally, the conductive tracks may extend into the capillaries in order to improve contact resistance.

A passivation layer 107 is formed over the insulating layer 103 and the conductive tracks 105A, 105B. An opening 108 is formed in the passivation layer 107. The opening 108 is the same size as the electrode opening 104, and is aligned with the opening 104. Additional holes 109A, 109B, 109C, 109D are formed in the passivation layer to allow connections to be made between the electrodes (discussed below) and external circuit elements. Additional holes may be added for sensors with more than two electrodes.

As FIG. 1 shows a cross-section through the sensor 100, only a working electrode 110A and a counter electrode 110B are shown. The working electrode 110A is formed in the openings 104 and 108. The electrode completely fills the openings 104 and 108 and abuts the top surface of the gas permeable hydrophobic barrier 200. The hydrophobic barrier 200 encourages the electrolyte 114 to remain within the gas sensor package and, more specifically, prevents or restricts it from leaving via the microcapillaries 102. An additional effect of the hydrophobic barrier 200 is that water is prevented or restricted from entering the microcapillaries from outside the gas sensor package, reducing the chance of contaminants entering the sensor, or the electrolyte absorbing water.

The hydrophobic barrier 200 may be applied using traditional dispensing, screen or stencil printing, or semiconductor processes. For example, the hydrophobic barrier 200 may be a PTFE dispersion. PTFE may be made super-hydrophobic using plasma treatment. As an alternative, the hydrophobic barrier 200 may be formed by treating the surfaces of the substrate to give them hydrophobic properties.

However, in this example, the hydrophobic barrier 200 is a gas permeable hydrophobic membrane in the form of a discrete polytetrafluoroethylene (PTFE) disc (more details below).

The working electrode 110A extends approximately 25 μm above the top of the passivation layer 107. The working electrode 110A also extends into hole 109B. This provides an electrical connection to conductive track 105B, allowing connections to external circuit elements via hole 109A. A counter electrode 110B is formed in hole 109C. Counter electrode 110B also extends 25 μm above the passivation layer 107. The counter electrode 110B also extends into hole 109C. This provides an electrical connection to conductive track 105A, allowing connections to external circuit elements via hole 109D. The electrode 110A is printed directly on the hydrophobic barrier 200. As such, the electrolyte 114 may be liquid. The electrode 110A prevents the electrolyte 114 passing through the microcapillaries. The electrodes are porous and are made of a catalyst, such as platinum. The electrode 110A thus provides the 3-phase porous surface required for the chemical reactions to take place. The catalyst is a medium to high surface area porous catalyst, such as platinum black. Sufficient catalyst is provided to ensure sufficient catalytic activity throughout the sensors lifetime. The catalyst may also be one of platinum, gold, ruthenium, carbon black or iridium. Other appropriate materials may be used.

In very dry environments, the electrolyte may be susceptible to slowly drying out, owing to the porous nature of the electrode 110A. Furthermore, the electrolyte may be susceptible to absorbing water from the environment in very humid conditions, again owing to the porous nature of the electrode 110A. However, owing to the hydrophobic nature of the discrete PTFE disc 201 placed over the microcapillaries 102, both of these undesirable effects are mitigated. The discrete PTFE disc 201 may comprise either a pressure or temperature sensitive adhesive ring for attachment to the substrate. An electrode 110A may be formed in direct contact on top of the discrete PTFE disc 201. The nozzle may then be used to attach further components of the device die or housing.

The discrete PTFE disc 201 may be a GORE® Protective Vent, for example, which may have a typical thickness of 0.05-0.25 mm with a tolerance of +/−0.05 mm. These types of discrete PTFE disc are generally used to equalize pressure and reduce condensation by allowing air to flow freely into and out of the electrochemical sensor 100 whilst at the same time, they provide a durable barrier to protect the electronics inside the electrochemical sensor 100 from contaminants. However, in this case, they also provide the additional advantage of preventing or restricting electrolyte 114 from leaking away from the active region of the electrochemical sensor 100 which is defined by the electrodes 11A, 110B. The result is an electrochemical sensor with improved reliability, durability and a longer product life.

A cap 111 is formed over the electrodes 110A, 110B. In embodiments where additional electrodes are used, the cap 111 would also be formed over those electrodes. The cap may be formed from glass, ceramic, silicon or plastic. The cap 111 is sealed to the passivation layer 107 by epoxy/adhesive or frit glass 112A, 112B. Other bonding techniques may be used. A hole 113 is formed in the top of the cap 111. An electrolyte 114 is provided within the cap 111. In another aspect, two or more holes may be formed in the cap 111. This would enable the electrolyte to be vacuum filled. The electrolyte 114 may be made from a liquid solution, such as a conductive aqueous electrolyte or organic electrolyte, a conductive polymer, such as Nafion or PEDOT:PSS. The electrolyte may also be a hydrogel or a room temperature ionic liquid. In one example, the electrolyte may be sulfuric acid solution and may include a wicking material or wicking substructure. The electrolyte may be a two-layer electrolyte. The electrolyte 114 completely covers the electrodes, but when using liquid electrolytes, does not completely fill the cap 112. Instead, a void space 115 is left towards the top of the cap 111. The void space 115 may not be required when using conductive polymer electrolytes, hydrogels and some other non-aqueous electrolytes. Epoxy glue or a sealing tape 116 (or any other organic polymeric material) is formed over the hole or holes 113 to prevent or restrict any pollutants entering the cap, and also to prevent or restrict the electrolyte 114 from leaving the cap. Other options may be utilized for sealing. If two holes are provided in the cap 111, a seal may be formed over both holes. In another aspect, a larger hole could be covered with an adhered lid, once the cavity is filled.

If the cap 111 is made from plastic, the plastic material must be compatible with the electrolyte 114. Various plastic materials may be used. For example, the cap may be made from acrylonitrile butadiene styrene (ABS), PTFE, polycarbonate (PC), polyethylene (PE), amongst other plastics. Important properties of the plastic are its chemical resistance and its compatibility with the electrolytes.

In FIG. 1, the conductive tracks 105A, 105B are provided over the insulating layer 103. The openings 109A, 109D are provided outside of the cap 111 in order to allow the sensor to be connected to external devices. It may be preferable to omit the portion of the substrate 101 and insulting layer 103 that extend outside of the cap 111, in order to reduce the size of the sensor 100. In order to facilitate this, the conductive tracks may be omitted, and conductive vias may be formed through the substrate instead. This would enable connections to be made on the underside of the substrate 101. Additionally, the size of the substrate 101 may be reduced to the size of the cap 111.

The microcapillaries 102 may be lined with an insulating material. The purpose of this would be to electrically insulate the silicon substrate 101 from the electrodes.

FIG. 1B shows a plan view of an example sensor 100 with the cap 111 and the electrolyte 114 removed for clarity. The PTFE disc 201 is placed on top of the microcapillaries through the opening in the insulating layer (both not shown in FIG. 1B).

The configuration of the sensor conductive tracks and electrodes in FIG. 1B slightly differs from that shown in FIG. 1A their shape and arrangement relative to the other sensor components. In FIG. 1B, the sensor 100 also includes conductive tracks 706A, 706B and 706C. The conductive tracks are shown in broken lines, as they are all positioned below the passivation layer. Conductive track 706A is for connecting the working electrode 704A. The conductive track includes a ring-shaped portion, which is located around the capillaries 702, but within the outer edge of the working electrode 704A. The ring-shaped portion is co-axial with the working electrode 704A. A ring-shaped opening is formed in the passivation layer, and is aligned with the ring-shaped portion of the conductive track 706A, in order to allow the working electrode 704A to connect to the conductive track 706A. A rectangular connecting portion of track 706A is formed at the bottom edge of the ring-shaped portion, to provide a connection to external circuitry.

Conductive tracks 706B and 706C are formed partially underneath counter electrode 704B and reference electrode 704C respectively. Each track includes a semi-annular portion which is the same shape as the corresponding electrode, but slight smaller in size. As such, the semi-annular portions fit within the perimeters of their respective electrodes. Openings are provided in the passivation layer to enable the conductive tracks 706B and 706C to connect to the working electrode 704B and reference electrode, respectively. These openings are similar in size and shape to the semi-annular portions of the conductive tracks 706B and 706C. In a similar manner to the conductive track 706A, the conductive tracks 706B and 706C include rectangular portions which extend from an outer edge of the semi-annular portions to provide connections to external circuitry.

The purpose of using a circular and semi-annular arrangement is to reduce and optimise the distance and spacing between the electrodes. This reduces the resistance path between the electrodes, which can affect the sensor performance, including speed of response. For example, in a carbon monoxide sensor, there's ion movement, or transport, between the electrodes in the sensor. Ideally, therefore, the electrodes (including the entire electrode area) should be as close together as possible. Using circular and semi-annular electrodes makes this easier to achieve.

FIG. 1B shows a sensor with components that have particular relative dimensions. These dimensions may be altered. For example, the PTFE disc 201 may be much larger than shown in FIG. 1B relative to the electrodes, or it may be much smaller. The length and width of each sensor may be in the range of 1 mm to 10 mm. The overall thickness, including the substrate 101 and the cap 111 may be 1 mm. As such, on a typical 200 mm wafer, in excess of 1000 sensors may be produced.

In use, the sensor would be connected to a micro-controlled measurement system in a manner familiar to those skilled in the art. The sensor output may be continuously monitored and used to determine the concentration of analyte in the environment. The electrode 110A may come into contact with environmental gases via the microcapillaries 102 and the gas permeable PTFE disc 201. As the electrode 110A is porous, the environmental gases are able to pass through the electrode to a point where they come into contact with the electrolyte 114. A three-phase junction is therefore formed within the electrode. An advantage of using a printed, solid electrode 110A, is that it prevents or restricts the electrolyte 114 from escaping through the microcapillaries 102 in the substrate 101.

An advantage of the above-described structure is that silicon micromachining techniques can be used in its construction. As such, manufacturing of the sensor is compatible with fabrication techniques used to manufacture integrated circuits. By manufacturing multiple sensors in parallel, variations in the parameters of the sensors are reduced.

A further advantage of using silicon fabrication techniques is that the cost of each device is reduced. This is because each process step is applied to multiple sensors in parallel, so the processing cost per device is small. Additionally, micromachining techniques enable very small devices to be produced. As such, the sensors may be more easily incorporated into handheld devices. Furthermore, the sensors all see the same processing steps at the same time. As such, matching between devices is very good when compared with serially produced devices.

A method of fabricating the electrochemical sensor 100 will now be described with reference to FIGS. 1C to 1L.

FIG. 1C shows the first step in the fabrication process. A silicon wafer is used as the silicon substrate 101. In the following, the process for forming one device will be described, however several hundred devices may be formed in parallel on the same wafer. The silicon substrate 101 is used for mechanical support, and could be substituted for another type of material, such as glass.

An oxide insulating layer 103 is deposited on the wafer, as shown in FIG. 1D. The oxide layer serves as a “landing” oxide to stop the through wafer etch, and also serves as a layer to insulate the conductive tracks from the substrate to prevent shorting.

The microcapillaries 102 are defined in the wafer by photolithography. The microcapillaries are etched through the wafer using an isotropic dry etch. They are etched from the backside of the wafer and stop at the oxide layer once the silicon wafer has been etched through, as shown in FIG. 1E.

FIG. 1F shows formation of inert metal layers which form the conducting tracks 105. They are deposited on the insulation layer, on the front side of the wafer. An adhesive layer 106 is first deposited on the insulating layer 103, and is used to attach the metal layer to the insulating layer 103. The conductive tracks may be defined by photolithography and then etched. The thickness of the inert metal can be increased by electroplating in specific areas, as defined by photolithography.

FIG. 1G shows the sensor after deposition and definition of the passivation layer 107. The insulating oxide 103 on the front side of the wafer 101 is removed in the region of the microcapillaries 102 using a wet etch, as shown in FIG. 1H.

In FIG. 1I, a PTFE disc 201 is placed on top of the microcapillaries 102. This step can be achieved using a nozzle that picks up the discrete PTFE disc 201 by vacuum and places it on and in contact with the substrate over the microcapillaries 102.

A porous electrode material is deposited on the wafer using screen printing, stencil printing, electroplating, or other lithographic deposition techniques to form electrodes 110A and 110B, as shown in FIG. 1J. Electrode 110A covers the microcapillaries 102, and connection is made to the conductive tracks.

The cap 111 is then placed over the sensor 100, as shown in FIG. 1K. As described above, the cap 111 may be made of plastic, ceramic, silicon or glass, amongst other materials. If the cap is made of plastic, it is prefabricated by injection molding. The recess and holes may be formed during the injection molding process. If the cap is made from glass, silicon or ceramic, the cap would typically be fabricated using wafer level processing techniques. For glass or ceramic caps, cavities can be made in the cap by firstly using photolithography to pattern the cap cavity. Then one of, or a combination of, wet etching, dry etching, sand blasting and laser drilling may be used to create the cavities in the cap. For silicon caps, cavities can be made in the cap by firstly using photolithography to pattern the cap cavity. Then one of, or a combination of, wet etching, dry etching, sand blasting, and laser drilling may be used to create the cavities in the cap.

The cap 111 is attached to the wafer through wafer bonding (wafer processing) or through placement with epoxy/adhesive on the sensor wafer (single cap placement process). Alternatively, the cap 111 may be attached by other means such as ultrasonics. The electrolyte 114 is dispensed through the cap hole 113 and the hole is sealed, as shown in FIG. 1L. As noted above, the cap 111 may have more than one hole.

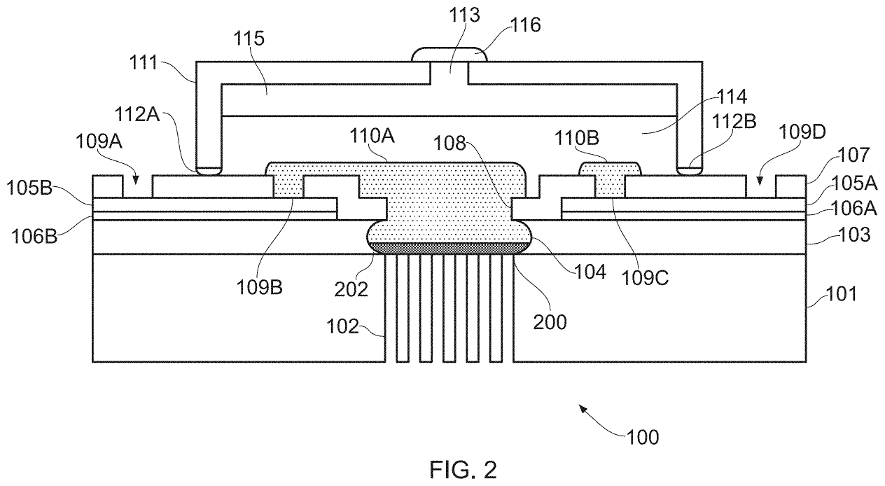

FIGS. 2-5 show alternative examples of the disclosure to FIG. 1. In FIGS. 2-5, like components with FIG. 1 are labelled with like reference numerals. One particular difference between FIGS. 2, 3 and 5 and FIG. 1 is that the side walls of the opening 104 are semi-circular in shape rather than straight since there is no need to place a discrete PTFE disc therein, which is pre-formed with straight sides.

FIG. 2 shows a cross-section through an electrochemical sensor 100 formed on silicon using micromachining techniques in accordance with a second example of the disclosure. In this example, instead of using a discrete PTFE disc 201 as the hydrophobic barrier 200, a PTFE ink or paste 202 is applied directly to the substrate 101 through the opening in the insulating 103 layer, and then the PTFE ink or paste 202 is baked for uniformity and to allow it to become gas permeable.

In some other examples, the PTFE ink or paste 202 could be applied together with using the PTFE disc 201, for example, above or below the PTFE disc 201. Thus, the hydrophobic barrier comprises both the PTFE ink or paste 202 and the PTFE disc 201.

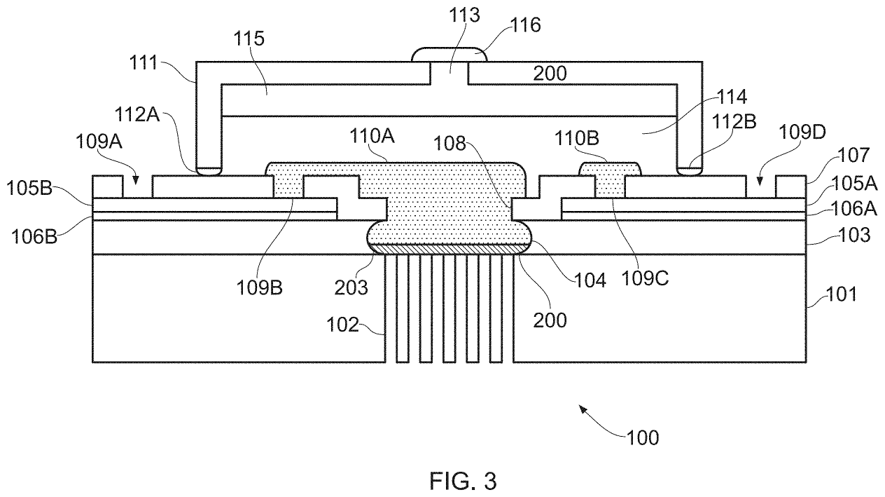

FIG. 3 shows a cross-section through an electrochemical sensor 100 formed on silicon using micromachining techniques in accordance with a third example of the disclosure. In this example, a layer of SU8 203 provides the hydrophobic barrier 200 and is formed directly onto the substrate 101 through the opening in the insulating 103 layer. SU8 is a photoresist that is hydrophobic but gas permeable so its presence does not adversely affect the device's gas sensing operation. In some examples, but not shown in FIG. 3, the layer of SU8 203 can have small openings that align with the microcapillaries 102. These small openings are smaller than the microcapillaries and so they are too small to allow any liquid electrolyte to pass through to escape the electrochemical sensor.

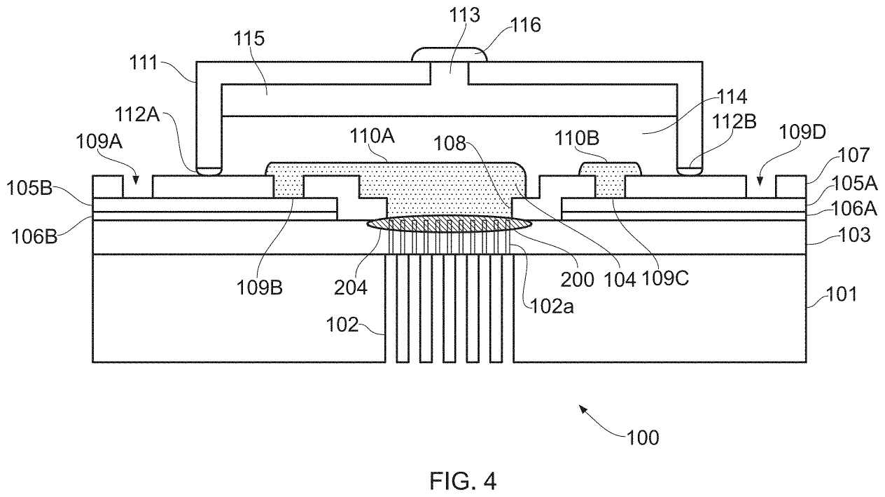

FIG. 4 shows a cross-section through an electrochemical sensor 100 formed on silicon using micromachining techniques in accordance with a fourth example of the disclosure. In this example, a layer of SU8 204 provides the hydrophobic barrier 200 and is formed directly onto the insulating layer 103. Since the insulating layer 103 is not gas permeable, it has openings through which gas may pass through. The SU8 layer 203 may also have openings in the form of micro or nanocapillaries that align with micro or nanocapillaries that are formed in the insulating layer 103 and/or the substrate 102. As is the case in FIG. 4, the openings in the SU8 are too small to allow any liquid electrolyte to pass through to escape the electrochemical sensor.

As an alternative example to FIG. 4, the hydrophobic barrier 200 could be provided by a layer of PTFE over the insulating layer 103 instead of SU8. The layer of PTFE could be a PTFE disc as in FIG. 1 or a PTFE ink or paste as in FIG. 2. In these examples, the insulating layer 103 also has openings through which gas may pass through since the insulating layer 103 itself is not gas permeable. The PTFE layer may also have openings in the form of micro or nanocapillaries that align with micro or nanocapillaries that are formed in the insulating layer 103 and/or the substrate 102. The openings in the PTFE layer are too small to allow any liquid electrolyte to pass through to escape the electrochemical sensor.

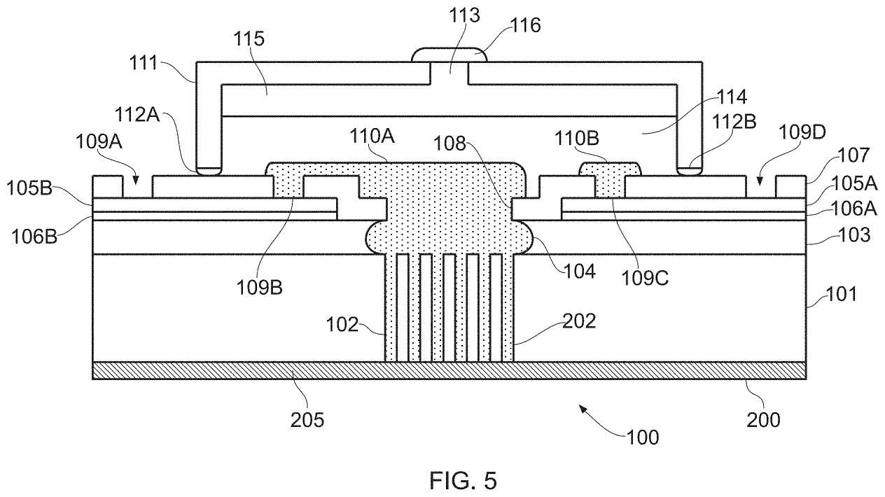

FIG. 5 shows a cross-section through an electrochemical sensor 100 formed on silicon using micromachining techniques in accordance with a fifth example of the disclosure. In this example, the hydrophobic barrier 200 is formed as a hydrophobic tape 205 on the under surface of the substrate 101. The hydrophobic tape 205 could be made of Parylene® or GORE PTFE®. The microcapillaries 102 are also filled 202 with the porous working electrode 110A. If the electrolyte 114 passes through the porous electrode 110A down through the microcapillaries, it is prevented or restricted from leaving the sensor by the hydrophobic tape. Further, water-based substances are prevented or restricted from entering the microcapillaries 102 from the back-end of the substrate. Further, condensation is prevented or restricted from forming in the microcapillaries, therefore reducing the chances of the microcapillaries being blocked.

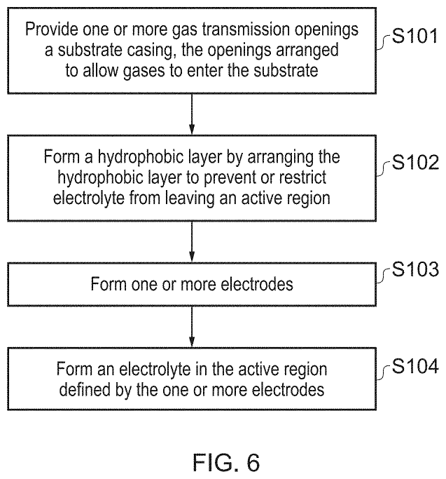

FIG. 6 is a flow diagram illustrating various steps in a method of manufacturing an electrochemical sensor according to an example of the disclosure. The method initially involves, at step S101, providing one or more gas transmission openings into a substrate, the openings arranged to allow gases to enter the substrate. Then, at step S102, a gas permeable hydrophobic layer is formed by arranging the hydrophobic layer to prevent or restrict the electrolyte from drying out or from leaving the electrochemical sensor. Then, at step S103, two or more electrodes are formed to define the active region. Finally, at step S104, an electrolyte is formed in the active region defined by the two or more electrodes.

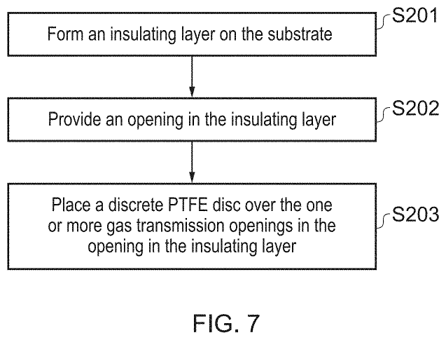

FIGS. 7 to 11 are a flow diagrams illustrating various options for additional steps in the method, in particular, for creating the hydrophobic layer. All of these options include step S201, forming an insulating layer on top of the substrate.

Four of the options in FIGS. 7 to 10 include step S202, which involves providing an opening in the insulating layer.

In FIG. 7, at step S203, a discrete PTFE disc may be placed over the one or more gas transmission openings in the opening in the insulating layer.

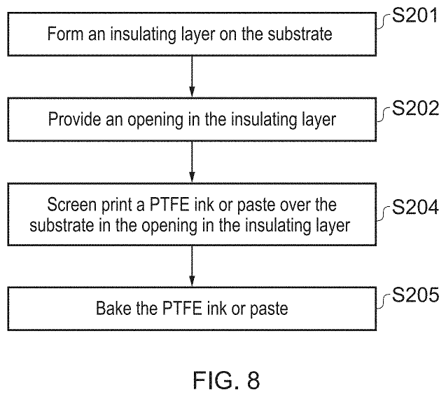

In FIG. 8, at steps S204 and S205, a PTFE ink or paste may be screen printed over the substrate in the opening in the insulating layer and then baked.

In some examples, the steps of FIGS. 7 and 8 may be combined and the PTFE ink or paste may be screen printed over the PTFE disc rather than being screen printed over the substrate. In these examples, both the PTFE disc and the PTFE ink or paste may act as the hydrophobic layer.

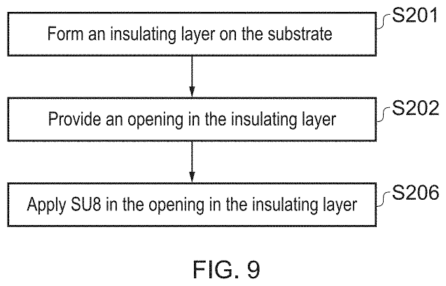

In FIG. 9, at step S206, SU8 is applied in the opening in the insulating layer.

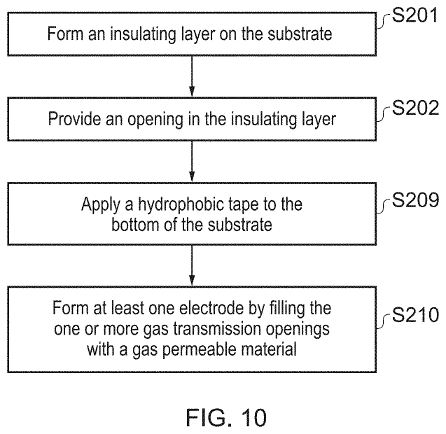

In FIG. 10, at step S209, a hydrophobic tape is applied to the bottom of the substrate to cover the one or more gas transmission openings and then, at step S210, at least one electrode is formed by filling the one or more gas transmission openings with a gas permeable material.

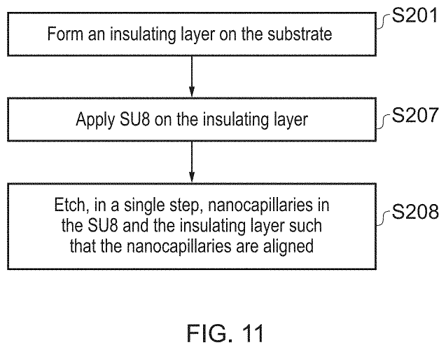

In the option where an opening is not provided in the insulating layer, in FIG. 11, after the insulating layer has been formed on the substrate, at step S207, SU8 is applied to the insulating layer and then, at step S208, a single etch is performed to create nanocapillaries in insulating layer and the SU8 that are aligned.

The above description relates to particularly preferred aspects of the disclosure, but it will be appreciated that other implementations are possible. Variations and modifications will be apparent to the skilled person, such as equivalent and other features which are already known and which may be used instead of, or in addition to, features described herein. Features that are described in the context of separate aspects or examples may be provided in combination in a single aspect or example. Conversely, features which are described in the context of a single aspect or example may also be provided separately or in any suitable sub-combination.

1. An electrochemical sensor, comprising:
a substrate having one or more gas transmission openings formed therein, the openings arranged to allow gases to pass through the substrate;
two or more electrodes;
an electrolyte; and
a hydrophobic layer arranged to prevent or restrict the electrolyte from drying out or from leaving the electrochemical sensor.

2. An electrochemical sensor according to claim 1, wherein at least one electrode is arranged over the hydrophobic layer.

3. An electrochemical sensor according to claim 2, wherein the at least one electrode is arranged to contact the hydrophobic layer.

4. An electrochemical sensor according to claim 1, wherein the hydrophobic layer is arranged above the substrate and over the one or more gas transmission openings.

5. An electrochemical sensor according to claim 3, wherein the electrochemical sensor further comprises an insulating layer and the hydrophobic layer is arranged in an opening in the insulator layer.

6. An electrochemical sensor according to claim 1, wherein the hydrophobic layer comprises a gas permeable hydrophobic membrane.

7. An electrochemical sensor according to claim 6, wherein the gas permeable hydrophobic membrane comprises a discrete polytetrafluoroethylene, PTFE, disc.

8. An electrochemical sensor according to claim 6, wherein the gas permeable hydrophobic membrane comprises a PTFE ink or paste.

9. An electrochemical sensor according to claim 5, wherein the hydrophobic layer comprises SU8 and the SU8 is arranged directly over the one or more gas transmission openings in a gap in the insulating layer, or wherein the SU8 is arranged directly over the insulating layer and the insulating layer comprises nanocapillaries aligned with nanocapillaries in the SU8.

10. An electrochemical sensor according to claim 1, wherein the hydrophobic layer is arranged below the substrate of the electrochemical sensor and below the one or more gas transmission openings.

11. An electrochemical sensor according to claim 10, wherein the hydrophobic layer comprises a hydrophobic tape and the at least one electrode against which the hydrophobic layer is directly arranged extends into the one or more gas transmission openings, and wherein the at least one electrode comprises a gas permeable material.

12. A gas sensor package, comprising:
a substrate having one or more gas transmission openings formed therein, the openings arranged to allow gases to enter the substrate;
a porous electrode;
a liquid electrolyte formed on top of the electrode;
a hydrophobic layer arranged to directly contact the electrode and arranged to repel electrolyte from passing through the electrode and out of the electrochemical sensor.

13. A method of manufacturing an electrochemical sensor, the method comprising:
providing a substrate having one or more gas transmission openings, the openings arranged to allow gases to pass through the substrate;
forming a hydrophobic layer;
forming two or more electrodes; and
forming an electrolyte over the two or more electrodes,
wherein forming the hydrophobic layer comprises arranging the hydrophobic layer to prevent or restrict the electrolyte from drying out or from leaving the electrochemical sensor.

14. A method according to claim 13, wherein the step of forming the at least two electrodes comprises forming at least one electrode over the hydrophobic layer, and preferably forming said at least one electrode in contact with the hydrophobic layer.

15. A method according to claim 13, wherein the method further comprises forming an insulating layer on the substrate.

16. A method according to claim 15, wherein the method further comprises providing an opening in the insulating layer and placing a discrete PTFE disc over the one or more gas transmission openings in the opening in the insulating layer.

17. A method according to claim 15, wherein the method further comprises providing an opening in the insulating layer, screen printing a PTFE ink or paste over the substrate in the opening in the insulating layer and baking the PTFE ink or paste such that it becomes gas permeable.

18. A method according to claim 15, wherein the method further comprises providing an opening in the insulating layer and applying SU8 in the opening in the insulating layer.

19. A method according to claim 15, wherein the method further comprises applying SU8 above the insulator layer and etching, in a single etching step, micro or nanocapillaries in the SU8 and the insulating layer such that the micro or nanocapillaries are aligned.

20. A method according to claim 15, wherein the method further comprises applying a hydrophobic tape to the bottom of the substrate and forming at least one electrode by filling the one or more gas transmission openings with a gas permeable material.
